(19) United States
(12) Patent Application Publication
(10) Pub. No.: US 2006/0117219 A1
(43) Pub. Date: Jun. 1, 2006

(54) Control device

(75) Inventors: Hirotoshi Inoue, Kawasaki (JP); Makoto Takamatsu, Kawasaki (JP); Michisada Sugimoto, Kawasaki (JP); Terumasa Haneda, Kawasaki (JP); Toshiyuki Yoshida, Kawasaki (JP); Yuichi Ogawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/094,693

(22) Filed: Mar. 31, 2005

(30) Foreign Application Priority Data
Nov. 11, 2004 (JP) 2004-328006

(51) Int. Cl. G06F 11/00

(52) U.S. Cl. 714/11

(57) ABSTRACT

Arbitrary data is read out from a main storage device, based on a permanent fault detection address that is used to detect a permanent fault on an address line. A bit error in the permanent fault detection address is detected and corrected, based on an error correcting code included in the arbitrary data read out. A permanent fault on the address line is determined, based on results of the error detection/correction.

### BACKGROUND OF THE INVENTION

1) Field of the Invention

The present invention relates to a control device capable of specifying a permanent fault on an address line effectively, without writing a permanent fault detection data to a main storage device during system operation.

2) Description of the Related Art

A conventional control device is well known, which writes arbitrary data to a memory or reads out arbitrary data from the memory, based on an address specified via an address bus that is made of a plurality of address lines. In such a control device, when a permanent fault on an address line is detected, a permanent fault detection data is written to a memory at least once via the address bus, and then the permanent fault detection data is read out from the memory. Thus, an abnormality such as short and break occurring on an address line can be detected from the data read out. For example, Japanese Patent Application Laid-Open Publication No. 1988-239547 discloses a conventional technology in which binary 1 is applied as a code to at least one of the plurality of address lines of the memory to write a permanent fault detection data to the address, and then data from the plurality of addresses is read out, thereby detecting a permanent fault on the address line, occurring due to a short or a break within a short time.

However, to detect a permanent fault on an address line as in the conventional technology disclosed above, there is a problem that a permanent fault detection data must be written to a main storage device during system operation, irrespectively of the presence or absence of a permanent fault on the address lines. Such a problem can be handled by transferring data stored in the main storage device to another storage unit temporally, during detection of a permanent fault on the address lines. However, this results in extra work, and reduces efficiency.

### SUMMARY OF THE INVENTION

It is an object of the present invention to at least solve the problems in the conventional technology.

According to an aspect of the present invention, a control device includes a memory that stores arbitrary data, wherein the arbitrary data is read/written based on an address specified via an address bus that includes a plurality of address lines, and the arbitrary data includes an error correcting code of the address; a data reading unit that reads out the arbitrary data from the memory, based on a permanent fault detection address that is used to detect a permanent fault on the address line; an error detecting/correcting unit that detects/corrects a bit error in the permanent fault detection address, based on the error correcting code; and a permanent fault deciding unit that decides any one of a zero-permanent-fault and a one-permanent-fault on the address line, based on results of the error detection/correction performed.

According to another aspect of the present invention, a method of detecting a permanent fault on an address line, the address line specifying an address of arbitrary data that includes an error correcting code of the address includes reading out the arbitrary data from a memory, based on a permanent fault detection address that is used to detect a permanent fault on the address line; detecting a bit error in the permanent fault detection address, based on the error correcting code; correcting the bit error in the permanent fault detection address, based on the error correcting code; and deciding any one of a zero-permanent-fault and a one-permanent-fault on the address line, based on results obtained at the detecting and at the correcting.

According to still another aspect of the present invention, a recording medium stores therein a computer program that implements the above method on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of a control device, a bus, and a main storage device of a computer according to a first embodiment;

FIG. 2 illustrates a configuration of an address and a data transmitted by an address bus and a data bus shown in FIG. 1;

FIG. 3 is an example of patrol check using a zero permanent fault detection address generated by a permanent fault detection address generating unit shown in FIG. 1;

FIG. 4 is an example of patrol check using a one permanent fault detection address generated by the permanent fault detection address generating unit shown in FIG. 1;

FIG. 5 illustrates criteria of permanent fault by patrol check using the permanent fault detection address shown in FIG. 3 or FIG. 4;

FIG. 6 illustrates a specific example of a case of patrol check using the permanent fault detection addresses shown in FIGS. 3 and 4, when there is no write-in to a memory after the permanent fault occurs on an address line;

FIG. 7 illustrates a specific example of a case of patrol check using the permanent fault detection addresses shown in FIGS. 3 and 4, when there is write-in to the memory after the permanent fault occurs on the address line;

FIG. 8 is a flowchart of process procedures of permanent fault detection on the address lines, performed by the control device shown in FIG. 1;

FIG. 9 illustrates a system configuration of a computer system according to a second embodiment; and

FIG. 10 is a block diagram of a main unit in the computer system shown in FIG. 9.

### DETAILED DESCRIPTION

Exemplary embodiments of the present invention will be explained in detail below, with reference to the accompanying drawings.

A case in which the control device according to the present invention is applied to a computer is explained as a first embodiment. Here, the explanation is provided in the order of (1) general outline and characteristics of the control device, bus, and main storage device of the computer, (2) configurations of the control device, bus and main storage device of the computer, (3) patrol check and decision of permanent fault using permanent fault detection addresses, (4) specific examples of patrol check, (5) procedures of permanent fault detection on address lines.

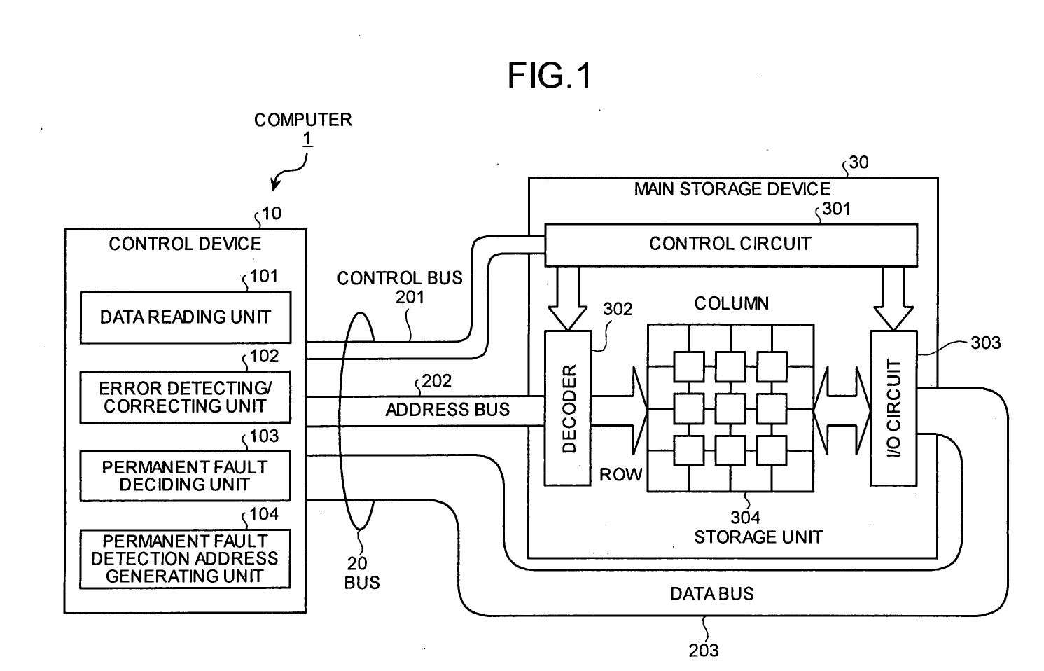

First, a general outline and characteristics of the control device, bus, and main storage device of the computer according to the present invention are explained. FIG. 1 is a functional block diagram of configurations of the control device, bus, and main storage device of the computer according to the first embodiment. As shown in FIG. 1, only the configurations of a control device 10, a bus 20, and a main storage device 30 of the computer that are directly related to the present invention are shown, and the other configurations are omitted.

The control device 10 according to the first embodiment is a central processing unit (CPU) that writes arbitrary data to the main storage device 30, based on an address specified via an address bus that is composed of a plurality of address lines, or reads out arbitrary data from the main storage device 30. The control device 10 specifies efficiently, a permanent fault of an address line, without writing a permanent fault detection data to the main storage device 30 during the system operation.

Further, the arbitrary data includes an error correcting code of an address. A data reading unit 101 reads out arbitrary data from the main storage device 30, based on any one of a zero permanent fault detection address that is an address to detect a zero permanent fault on the plurality of address lines, and a one permanent fault detection address that is an address to detect a one permanent fault on the plurality of address lines or both. An error detecting/correcting unit 102 detects/corrects a bit error of any one of the zero permanent fault detection address and the one permanent fault detection address or both, based on the error correcting codes. A permanent fault deciding unit 103 decides a zero permanent fault or a one permanent fault on the address line, based on the results of error detection/correction. Therefore, it is possible to specify a permanent fault on an address line efficiently, without writing a permanent fault detection data to the main storage device during the system operation.

An address bus 202 specifies an address with a row address and a column address via the same address line by time sharing. Further, using an error correcting code, a single bit error can be corrected, and double bit errors can be detected. The error correcting code may be a code such as Hamming code.

Configurations of the control device 10, the bus 20, and the main storage device 30 of the computer according to the first embodiment are explained next, with reference to FIG. 1. The control device 10 controls an entire computer 1, and includes the data reading unit 101, the error detecting/correcting unit 102, the permanent fault deciding unit 103, and a permanent fault detection address generating unit 104.

The data reading unit 101 reads out arbitrary data from the main storage device 30, based on one or both of the zero permanent fault detection address that is an address to detect a zero permanent fault on an address line, and the one permanent fault detection address that is an address to detect a one permanent fault on an address line. Further, the error detecting/correcting unit 102 detects/corrects a bit error of one or both of the zero permanent fault detection address and the one permanent fault detection address, based on the error correcting codes included in the arbitrary data read out by the data reading unit 101.

The permanent fault deciding unit 103 decides a zero permanent fault or a one permanent fault on the address line, based on the results of the detection/correction. Further, the permanent fault detection address generating unit 104 generates permanent fault detection addresses, including the zero permanent fault detection address and the one permanent fault detection address, from the main storage device 30 via the address bus 202. The permanent fault detection address is explained in detail later.

The bus 20 transmits data between the control device 10 and the main storage device 30, and has a control bus 201, the address bus 202, and a data bus 203. The control bus 201 transmits control data such as read-out and write-in of data to the main storage device 30, and has four control lines when it is a four-bit bus.

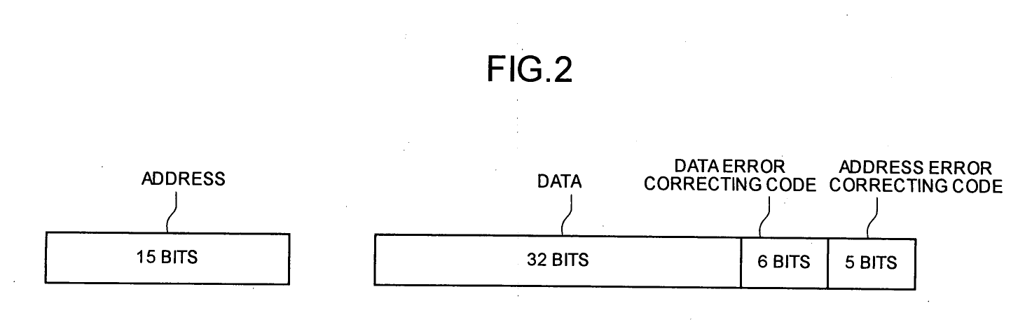

The address bus 202 specifies an address of data that is read from and written to the main storage device 30. The address bus has, for example, 32 address lines when it is 32 bits. However, in the first embodiment, the address bus is 15 bits, and specifies an address with a row address and a column address via the same address line by time sharing. The data bus 203 transmits data to be written from the control device 10 to the main storage device 30, and data to be read out from the main storage device 30 to the control device 10. Next, the configuration of the address and the data that are transmitted by the address bus 202 and the data bus 203 shown in FIG. 1 is explained with reference to FIG. 2.

As shown in FIG. 2, the address is 15 bits and the data is 32 bits. A six-bit data error correcting code, and a five-bit address error correcting code are added to the data. The six-bit data error correcting code and the five-bit address error correcting code are Hamming codes with which, for example, single bit errors can be corrected and double bit errors can be detected. In the first embodiment, the data error correcting code is not directly related to the present invention, and therefore, when error correcting code is referred to, it represents address error correcting code.

Returning to the explanation of FIG. 1, the main storage device 30 stores programs and data, based on a request made by the control device 10. The main storage device 30 includes a control circuit 301, a decoder 302, an input/output (I/O) circuit 303, and a storage unit 304. The control circuit 301 receives a control request such as write-in and read-out made by the control device 10 via the control bus 201, and controls the decoder 302 and the I/O circuit 303.

The decoder 302 specifies a physical row and column of the storage unit 304, based on the address transmitted from the control device 10 via the address bus 202, and locates a corresponding memory element in the storage unit 304. Further, the I/O circuit 303 writes data transmitted via the data bus 203 to the storage unit 304, or reads out the data from the storage unit 304. Furthermore, the memory elements in the storage unit 304 store data as electric signals, and are arranged in a two-dimensional array, and is configured with memory elements such as those in a dynamic random access memory (DRAM).

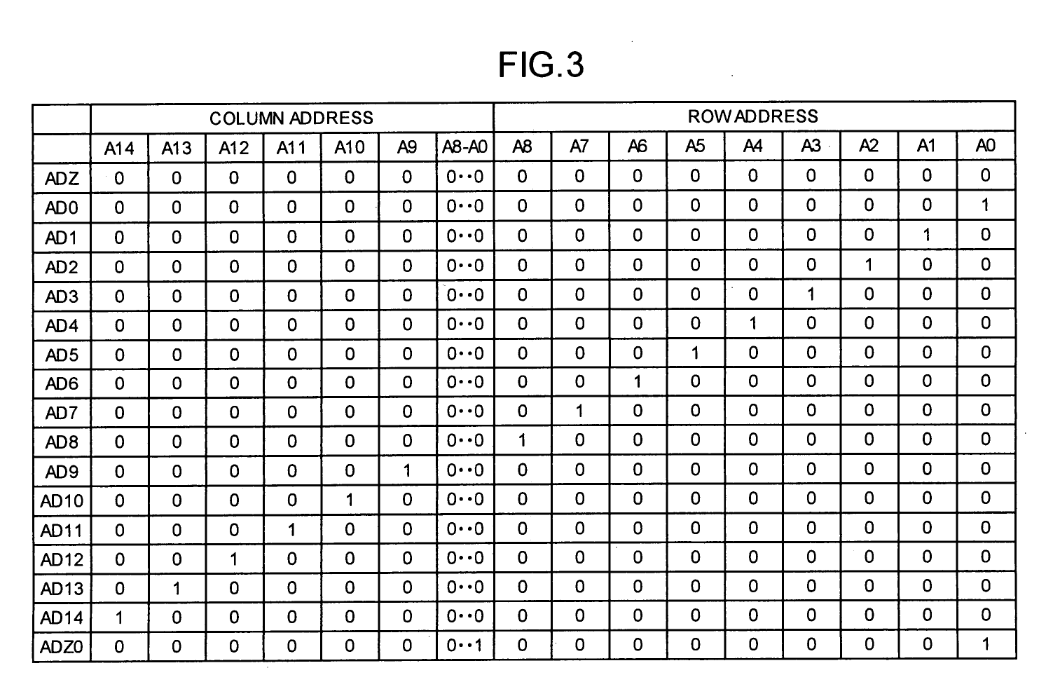

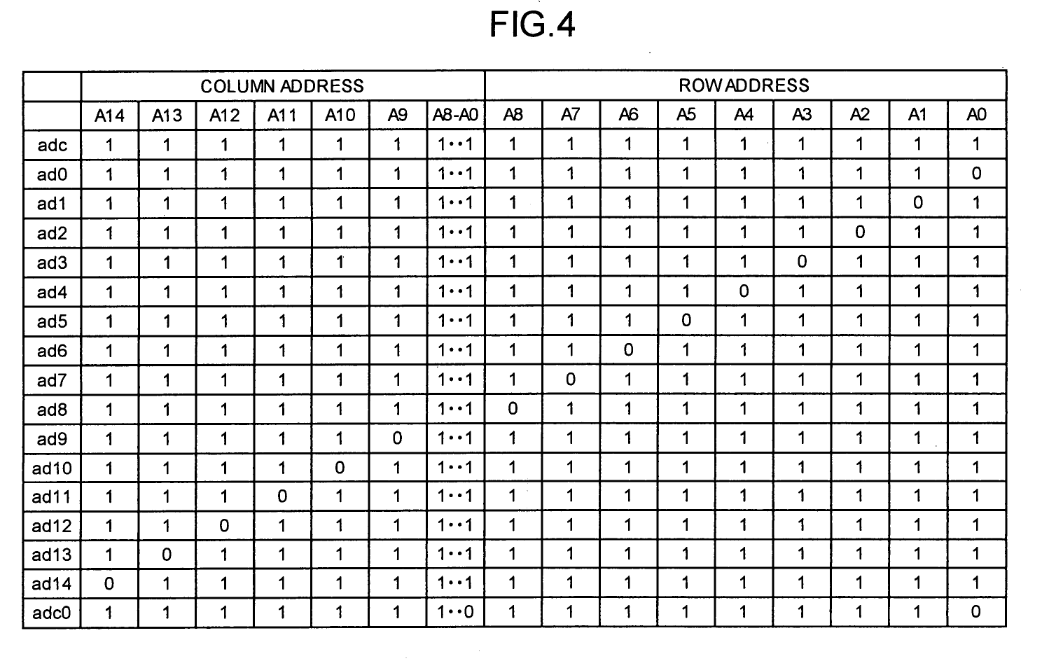

Next, one example of patrol check using a permanent fault detection address generated by the permanent fault detection address generating unit 104, is explained with reference to FIGS. 3 and 4. FIG. 3 is an example of patrol check using the zero permanent fault detection address generated by the permanent fault detection address generating unit 104. FIG. 4 is an example of the patrol check using the one permanent fault detection address generated by the permanent fault detection address generating unit 104.

The procedures of the patrol check based on FIGS. 3 and 4, respectively, are the same. Here, the patrol check based on FIG. 3 is explained first in detail. The horizontal axis of FIG. 3 includes row address and column address. The row address is a nine-bit address A0 to A8. The column address is a 15-bit address A0 to A14. Among the 15 bits of the column address, the two bits A13 and A14 are bank-select bits. Further, the bits A0 to A8 of the column address and the row address overlap each other. As described above, the address bus 202 of the first embodiment specifies an address with the row address and the column address via the same address line by time sharing.

The vertical axis of FIG. 3 illustrates seventeen zero permanent fault detection addresses. The zero permanent fault detection address includes first zero permanent fault detection addresses ADi (i=0 to 14) that are addresses having any one arbitrary bit of the row address or the column address corresponding to an address line to detect a zero permanent fault set to 1, and all the other bits to 0, a second zero permanent fault detection address ADZ having all bits set to 0, and a third zero permanent fault detection addresses ADZi (i=0 to 14) that are addresses having any one arbitrary bit of both of the row address and the column address corresponding to an address line to detect a zero permanent fault set to 1 and all the other bits to 0.

The third zero permanent fault detection address AZD0 of the vertical axis of FIG. 3 is a permanent fault detection address ADZi (i=0) on the address line corresponding to the bit A0, and has the bit A0 of the row address and the bit A0 of the column address both set to 1, and all the other bits to 0. Although only the ADZ0 of the third zero permanent fault detection addresses is written in FIG. 4, the permanent fault detection addresses ADZi (i=1 to 14) corresponding to the bits A1 to A14 respectively exist, but are not shown.

Specifically, the third zero permanent fault detection address ADZi (i=1) of the address line corresponding to the bit A1 is represented as ADZ1, and has the bit A1 of the row address and the bit A1 of the column address both set to 1, and all the other bits to 0. In this way, up to the third zero permanent fault detection address ADZ8 on the address line corresponding to the bit A8, each bit of the row address and the column address overlaps each other. Therefore, each bit corresponding to the row address and the column address that overlaps each other is set to 1, and all the other bits to 0, whereby the third zero permanent fault detection addresses ADZi (i=0 to 8) are specified.

On the other hand, as for the third zero permanent fault detection address ADZ9 of the address line corresponding to the bit A9, the row address and the column address do not overlap each other, and therefore, only bit A9 of the column address is set to 1 and all the other bits to 0. In this manner, up to the third zero permanent fault detection address ADZ14 of the address line corresponding to the bit A14, the third zero permanent fault detection addresses ADZi (i=9 to 14) are specified similarly.

Using FIG. 3, zero permanent fault detection on the address lines is carried out as follows:

(a) The data reading unit 101 reads out data of the first zero permanent fault detection address ADi.

(b) The data reading unit 101 reads out the data of the first zero permanent fault detection address Adi, and reads out consecutively, data of the second zero permanent fault detection address ADZ. The reason for consecutively reading-out the data of the first zero permanent fault detection address ADi and the second zero permanent fault detection address ADZ is that the state of the memory changes when data writing is performed between reading out the data of the first zero permanent fault detection address ADi and reading out the data of the second zero permanent fault detection address ADZ. This makes it impossible to decide a permanent fault accurately.

(c) The error detecting/correcting unit 102 detects/corrects errors of the first zero permanent fault detection address ADi and the second zero permanent fault detection address ADZ, based on the error correcting codes of the data read out in (a) and (b).

(d) The permanent fault deciding unit 103 decides a zero permanent fault or a one permanent fault on the i-th address line, based on the results of error detection/correction in (c).
(e) The control device 10 reads out data of the first zero permanent fault detection address ADi and the second zero permanent fault detection address ADZ repeatedly for i=0 to 14, and the control device 10 decides zero permanent faults or one permanent faults on all 15 address lines.

The horizontal axis of FIG. 4 includes row address and column address similar to that of FIG. 3. The row address is a nine-bit address A0 to A8. Further, the column address is a. 15-bit address A0 to A14. Among the 15 bits of the column address, the two bits A13 and A14 are bank-select bits. Further, the bits A0 to A8 of the column address and the row address overlap each other. As described above, the address bus 202 of the first embodiment specifies an address with the row address and the column address via the same address line by time sharing.

The vertical axis of FIG. 4 represents seventeen one permanent fault detection addresses. The one permanent fault detection address includes first one permanent fault detection addresses adi (i=0 to 14) that are addresses having any one arbitrary bit of the row address or the column address corresponding to an address line to detect a one permanent fault set to 0, and all the other bits to 1, a second one permanent fault detection address adc having all bits set to 1, and a third one permanent fault detection addresses adci (i=0 to 14) that are addresses having any one arbitrary bit of both of the row address and the column address corresponding to an address line to detect a one permanent fault set to 0 and all the other bits to 1.

The third one permanent fault detection address adc0 of the vertical axis of FIG. 4 is the permanent fault detection address adci (i=0) of the address line corresponding to the bit A0, and has the bit A0 of the row address and the bit A0 of the column address set to 0, and all the other bits to 1. Although only the address adc0 of the third one permanent fault detection addresses is written in FIG. 4, the other permanent fault detection addresses adci (i=1 to 14) corresponding to the bits A1 to A14, respectively, exist, but are not shown.

Specifically, the third one permanent fault detection address adci (i=1) of the address line corresponding to the bit A1 is represented as adcd, and has the bit A1 of the row address and the bit A1 of the column address set to 0, and all the other bits to 1. In this way, up to the third one permanent fault detection address adc8 of the address line corresponding to the bit A8, each bit of the row address and the column address overlaps each other. Therefore, each bit corresponding to the row address and the column address that overlaps each other is set to 1, and all the other bits to 0, whereby the third one permanent fault detection addresses adci (i=0 to 8) are specified.

On the other hand, as for the third one permanent fault detection address adc9 of the address line corresponding to the bit A9, the row address and the column address do not overlap each other, and therefore, only one bit A9 of the column address is set to 0 and all the other bits to 1. In this manner, up to the third one permanent fault detection address adc14 of the address line corresponding to the bit A14, the third one permanent fault detection addresses adci (i=9 to 14) are specified similarly.

Using FIG. 4, one permanent fault detection on address lines is carried out as follows:

(a) The data reading unit 101 reads out data of the first one permanent fault detection address adi.

(b) The data reading unit 101 reads out the data of the first one permanent fault detection address adi, and reads out consecutively, data of the second one permanent fault detection address adc. The reason for consecutively reading-out the data of the first one permanent fault detection address adi and the second one permanent fault detection address adc is that the state of the memory changes when data writing is performed between reading out the data of the first one permanent fault detection address adi and reading out the data of the second one permanent fault detection address adc. This makes it impossible to decide a permanent fault accurately.

(c) The error detecting/correcting unit 102 detects/corrects errors of the first one permanent fault detection address adi and the second one permanent fault detection address adc, based on the error correcting codes of the data read out in (a) and (b).

(d) The permanent fault deciding unit 103 decides a zero permanent fault or a one permanent fault on the i-th address line, based on the results of error detection/correction in (c). =p1 (e) The control device 10 reads out data of the first one permanent fault detection address adi and the second one permanent fault detection address adc repeatedly for i=0 to 14, and the control device 10 decides zero permanent faults or one permanent faults on all 15 address lines.

In this manner, the permanent fault deciding unit 103 can decide a zero permanent fault or a one permanent fault on address lines by reading out arbitrary data (the number of address lines×the number of permanent fault detection addresses), for example, arbitrary data of 15×4=60 in a case of 15 address lines from the main storage device 30. Therefore, the control device 10 can specify a permanent fault on an address line easily and efficiently.

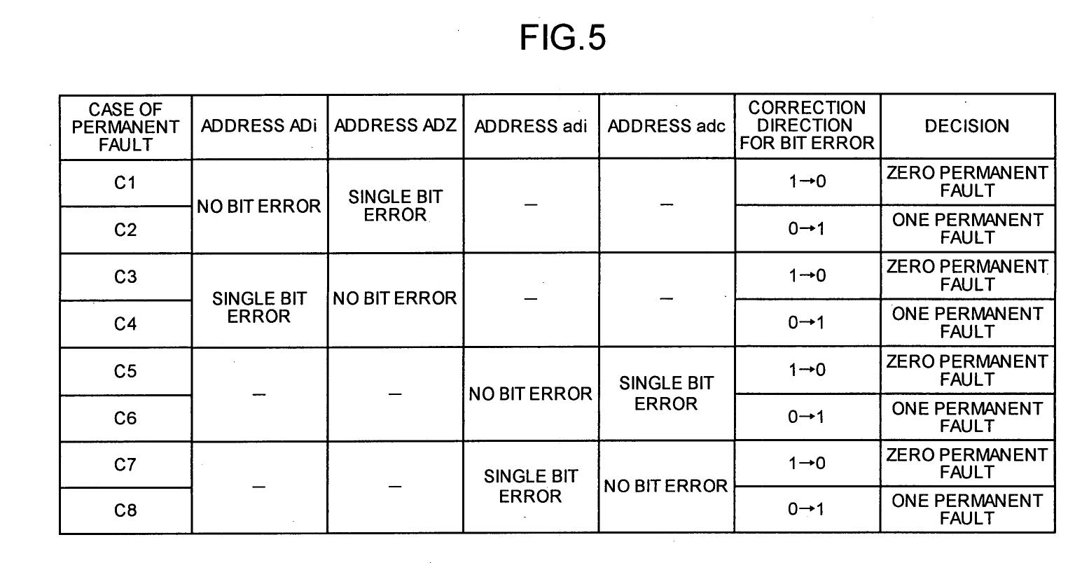

Next, the criteria of permanent fault by patrol check using the permanent fault detection addresses shown in FIGS. 3 and 4 is explained with reference to FIG. 5. The permanent fault deciding unit 103 decides a permanent fault in eight cases C1 to C8.

The error detecting/correcting unit 102 detects a single bit error from a syndrome using an error correcting code such as Hamming code, with which single bit errors can be corrected and double bit errors can be detected, and corrects the bit error detected based on an error pattern corresponding to the syndrome. In other words, the error detecting/correcting unit 102 specifies bits having a single bit error and corrects the single bit error of the specified bits. On the other hand, as for double bit errors, the error detecting/correcting unit 102 can detect double bit errors; however, it cannot specify which bits they are.

The permanent fault deciding unit 103 decides that in a case where either of the first zero permanent fault detection address or the second zero permanent fault detection address has a single bit error and the other has no bit error with respect to the bits corresponding to the address line, a one permanent fault occurs on the address line when the single bit error is corrected from 0 to 1, and that a zero permanent fault occurs on the address line when the single bit error is corrected from 1 to 0. Further, in a case where either of the first one permanent fault detection address or the second one permanent fault detection address has a single bit error and the other has no bit error with respect to the bits corresponding to the address line, the permanent fault deciding unit 103 decides that a one permanent fault occurs on the address line when the single bit error is corrected from 0 to 1, and that a zero permanent fault occurs on the address line when the single bit error is corrected from 1 to 0. Furthermore, the permanent fault deciding unit 103 does not decide any permanent fault when the error detecting/correcting unit 102 detects double bit errors.

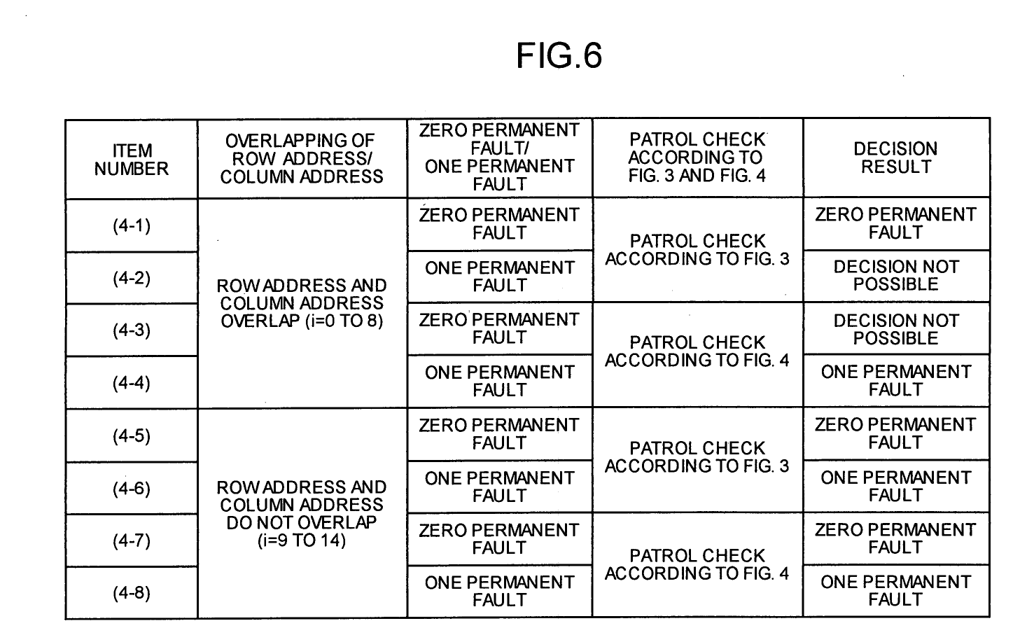

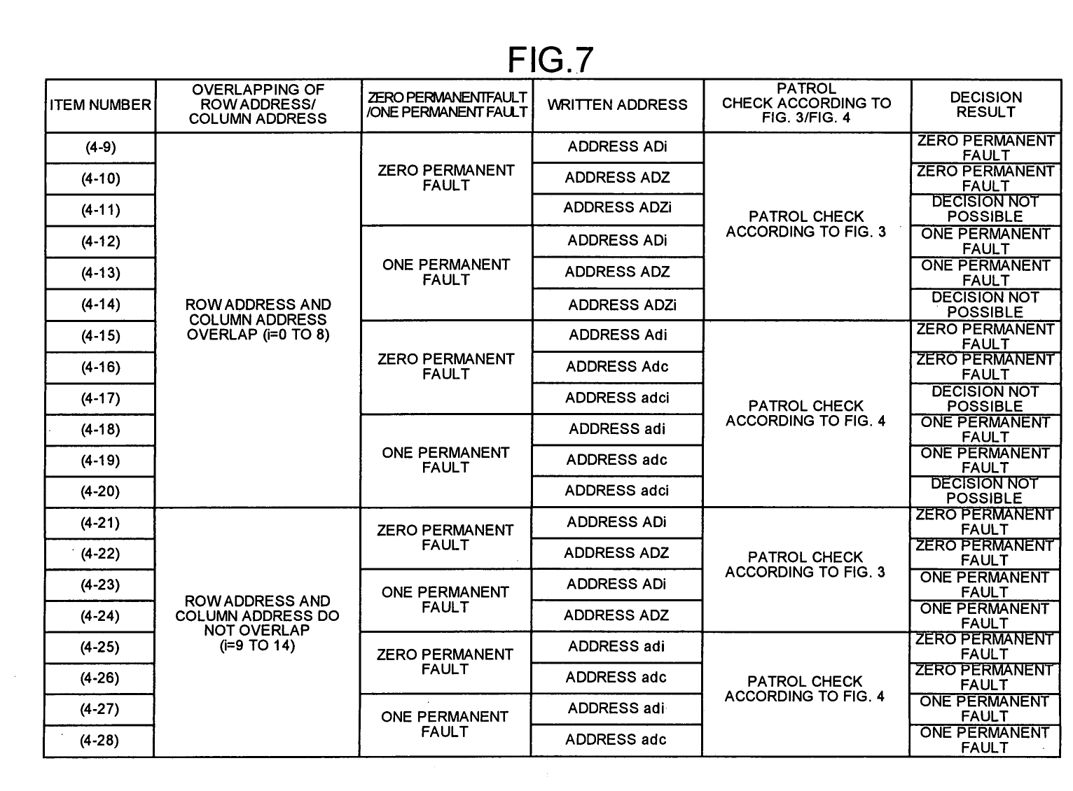

Specific examples of patrol check using the permanent fault detection addresses shown in FIGS. 3 and 4 are explained in detail, with reference to FIGS. 6 and 7. FIG. 6 illustrates a specific example of a case of patrol check using the permanent fault detection addresses shown in FIGS. 3 and 4 where there is no write-in to the memory after a permanent fault occurs on an address line. FIG. 7 illustrates a specific example of a case of patrol check using the permanent fault detection addresses shown in FIGS. 3 and 4 where there is write-in to the memory after a permanent fault occurs on an address line. The item numbers in FIGS. 6 and 7 correspond to the item numbers shown below.

(4-1) A case in which the row addresses and the column addresses overlap (i=0 to 8), and patrol check is carried out according to FIG. 3 without write-in after a zero permanent fault occurs.

(a) If any one of address lines corresponding to addresses ADi (i=0 to 8) has a zero permanent fault, the data reading unit 101 reads the data and the error correcting code of the address ADZ when it reads the addresses ADi, and therefore, the error detecting/correcting unit 102 detects that the bits corresponding to the address line have a single bit error, based on the addresses ADi and the error correcting code of the address ADZ, and then corrects the detected bit error from 1 to 0.

(b) If any one of the address lines corresponding to the addresses ADi has the zero permanent fault, the data reading unit 101 reads the data and the error correcting code of the address ADZ when it reads the address ADZ, and therefore, the error detecting/correcting unit 102 detects no bit error, based on the address ADZ and the error correcting code of the address ADZ.

(c) Accordingly, the permanent fault deciding unit 103 decides a zero permanent fault on the concerned address line, based on the results of error detection/correction of (a) and (b) as shown in case C3 of FIG. 5.

(4-2) A case in which the row addresses and the column addresses overlap (i=0 to 8), and patrol check is carried out according to FIG. 3 without write-in after a one permanent fault occurs.

(a) If any one of address lines corresponding to the addresses ADi (i=0 to 8) has a one permanent fault, the data reading unit 101 reads the data and the error correcting codes of the addresses ADZi (i=0 to 8) when it reads the addresses ADi, and therefore, the error detecting/correcting unit 102 detects that the bits corresponding to the address line have a single bit error, based on the addresses ADi and the error correcting codes of the addresses ADZi, and then corrects the detected bit error from 0 to 1.

(b) If any one of the address lines corresponding to the addresses ADi has the one permanent fault, the data reading unit 101 reads the data and the error correcting codes of the addresses ADZi when it reads the address ADZ, and therefore, the error detecting/correcting unit 102 detects double bit errors, based on the address ADZ and the error correcting codes of the addresses ADZi.

(c) Accordingly, the permanent fault deciding unit 103 cannot decide whether the concerned address line has a one permanent fault, based on the results of error detection/correction of (a) and (b).

(4-3) A case in which the row addresses and the column addresses overlap (i=0 to 8), and patrol check is carried out according to FIG. 4 without write-in after a zero permanent fault occurs.

(a) If any one of address lines corresponding to addresses adi (i=0 to 8) has a zero permanent fault, the data reading unit 101 reads the data and the error correcting codes of the addresses adci (i=0 to 8) when it reads the addresses adi, and therefore, the error detecting/correcting unit 102 detects that the bits corresponding to the address line have a single bit error, based on the addresses adi and the error correcting codes of the addresses adci, and then corrects the detected bit error from 1 to 0.

(b) If any one of the address lines corresponding to the addresses adi has the zero permanent fault, the data reading unit 101 reads the data and the error correcting codes of the addresses adci when it reads the address adc, and therefore, the error detecting/correcting unit 102 detects double bit errors, based on the address adc and the error correcting codes of the addresses adci.

(c) Accordingly, the permanent fault deciding unit 103 cannot decide whether the concerned address line has a zero permanent fault, based on the results of error detection/correction of (a) and (b).

(4-4) A case in which the row addresses and the column addresses overlap (i=0 to 8), and patrol check is carried out according to FIG. 4 without write-in after a one permanent fault occurs.

(a) If any one of address lines corresponding to the addresses adi (i=0 to 8) has a one permanent fault, the data reading unit 101 reads the data and the error correcting code of the address adc when it reads the addresses adi, and therefore, the error detecting/correcting unit 102 detects that the bits corresponding to the address line have a single bit error, based on the addresses adi and the error correcting code of the address adc, and then corrects the detected bit error from 0 to 1.

(b) If any one of the address lines corresponding to the addresses adi has the one permanent fault, the data reading unit 101 reads the data and the error correcting code of the address adc when it reads the address adc, and therefore, the error detecting/correcting unit 102 detects no bit error, based on the address adc and the error correcting code of the address adc.

(c) Accordingly, the permanent fault deciding unit 103 decides that the concerned address line has a one permanent fault, based on the results of error detection/correction of (a) and (b) as shown in case C8 of FIG. 5.

(4-5) A case in which the row addresses and the column addresses do not overlap (i=9 to 14), and patrol check is carried out according to FIG. 3 without write-in after a zero permanent fault occurs

(a) If any one of address lines corresponding to the addresses ADi (i=9 to 14) has a zero permanent fault, the data reading unit 101 reads the data and the error correcting code of the address ADZ when it reads the addresses ADi, and therefore, the error detecting/correcting unit 102 detects that the bits corresponding to the address line have a single bit error, based on the addresses ADi and the error correcting code of the address ADZ, and then corrects the detected bit error from 1 to 0.

(b) If any one of the address lines corresponding to the addresses ADi has the zero permanent fault, the data reading unit 101 reads the data and the error correcting code of the address ADZ when it reads the address ADZ, and therefore, the error detecting/correcting unit 102 detects no bit error, based on the address ADZ and the error correcting code of the address ADZ.

(c) Accordingly, the permanent fault deciding unit 103 decides that the concerned address line has a zero permanent fault, based on the results of error detection/correction of (a) and (b) as shown in case C3 of FIG. 5.

(4-6) A case in which the row addresses and the column addresses do not overlap (i=9 to 14), and patrol check is carried out according to FIG. 3 without write-in after a one permanent fault occurs

(a) If any one of address lines corresponding to the addresses ADi (i=9 to 14) has a one permanent fault, the data reading unit 101 reads the data and the error correcting codes of the addresses ADi when it reads the addresses ADi, and therefore, the error detecting/correcting unit 102 detects no bit error, based on the addresses ADi and the error correcting codes of the addresses ADi.

(b) If any one of the address lines corresponding to the addresses ADi has the one permanent fault, the data reading unit 101 reads the data and the error correcting codes of the addresses ADi when it reads the address ADZ, and therefore, the error detecting/correcting unit 102 detects that the bits corresponding to the address line have a single bit error, based on the address ADZ and the error correcting codes of the addresses ADi, and then corrects the detected bit error from 0 to 1.

(c) Accordingly, the permanent fault deciding unit 103 decides that the concerned address line has a one permanent fault, based on the results of error detection/correction of (a) and (b) as shown in case C2 of FIG. 5.

(4-7) A case in which the row addresses and the column addresses do not overlap (i=9 to 14), and patrol check is carried out according to FIG. 4 without write-in after a zero permanent fault occurs.

(a) If any one of address lines corresponding to the addresses adi (i=9 to 14) has a zero permanent fault, the data reading unit 101 reads the data and the error correcting codes of the addresses adi when it reads the addresses adi, and therefore, the error detecting/correcting unit 102 detects no bit error, based on the addresses adi and the error correcting codes of the addresses adi.

(b) If any one of the address lines corresponding to the addresses adi has the zero permanent fault, the data reading unit 101 reads the data and the error correcting codes of the addresses adi when it reads the address adc, and therefore, the error detecting/correcting unit 102 detects that the bits corresponding to the address line have a single bit error, based on the address adc and the error correcting codes of the addresses adi, and then corrects the detected bit error from 1 to 0.

(c) Accordingly, the permanent fault deciding unit 103 decides that the concerned address line has a zero permanent fault, based on the results of error detection/correction of (a) and (b) as shown in case C5 of FIG. 5.

(4-8) A case in which the row addresses and the column addresses do not overlap (i=9 to 14), and patrol check is carried out according to FIG. 4 without write-in after a one permanent fault occurs.

(a) If any one of address lines corresponding to the addresses adi (i=9 to 14) has a one permanent fault, the data reading unit 101 reads the data and the error correcting code of the address adc when it reads the addresses adi, and therefore, the error detecting/correcting unit 102 detects that the bits corresponding to the address line have a single bit error, based on the addresses adi and the error correcting code of the address adc, followed by correcting the detected bit error from 0 to 1.

(b) If any one of the address lines corresponding to the addresses adi has the one permanent fault, the data reading unit 101 reads the data and the error correcting code of the address adc when it reads the address adc, and therefore, the error detecting/correcting unit 102 detects no bit error, based on the address adc and the error correcting code of the address adc.

(c) Accordingly, the permanent fault deciding unit 103 decides that the concerned address line has a one permanent fault, based on the results of error detection/correction of (a) and (b) as shown in case C8 of FIG. 5.

(4-9) A case in which the row addresses and the column addresses overlap (i=0 to 8), write-in to the addresses ADi is carried out after a zero permanent fault occurs, and patrol check is carried out according to FIG. 3

(a) Because write-in to the addresses ADi (i=0 to 8) is carried out after a zero permanent fault occurs, the data of the addresses ADi and the error correcting codes of the addresses ADi are stored in the address ADZ.

(b) If any one of address lines corresponding to the addresses ADi has a zero permanent fault, the data reading unit 101 reads the data and the error correcting code of the address ADZ when it reads the addresses ADi, and therefore, the error detecting/correcting unit 102 detects no bit error, based on the addresses ADi and the error correcting codes of the addresses ADi stored in the address ADZ.

(c) If any one of the address lines corresponding to the addresses ADi has the zero permanent fault, the data reading unit 101 reads the data and the error correcting code of the address ADZ when it reads the address ADZ, and therefore, the error detecting/correcting unit 102 detects that the bits corresponding to the address line have a single bit error, based on the address ADZ and the error correcting codes of the addresses ADi stored in the address ADZ, and then corrects the detected bit error from 1 to 0.

(d) Accordingly, the permanent fault deciding unit 103 decides that the concerned address line has a zero permanent fault, based on the results of error detection/correction of (b) and (c) as shown in case C1 of FIG. 5.

(4-10) A case in which the row addresses and the column addresses overlap (i=0 to 8), write-in to the address ADZ is carried out after a zero permanent fault occurs, and patrol check is carried out according to FIG. 3.

(a) Because write-in to the address ADZ is carried out after a zero permanent fault occurs, the data of the address ADZ and the error correcting code of the address ADZ are stored in the address ADZ.

(b) If any one of address lines corresponding to the addresses ADi (i=0 to 8) has a zero permanent fault, the data reading unit 101 reads the address ADZ when it reads the addresses ADi, and therefore, the error detecting/correcting unit 102 detects that the bits corresponding to the address line have a single bit error, based on the addresses ADi and the error correcting code of the address ADZ stored in the address ADZ, and then corrects the detected bit error from 1 to 0.

(c) If any one of the address lines corresponding to the addresses ADi has the zero permanent fault, the data reading unit 101 reads the data and the error correcting code of the address ADZ when it reads the address ADZ, and therefore, the error detecting/correcting unit 102 detects no bit error, based on the address ADZ and the error correcting code of the address ADZ stored in the address ADZ.

(d) Accordingly, the permanent fault deciding unit 103 decides that the concerned address line has a zero permanent fault, based on the results of error detection/correction of (b) and (c) as shown in case C3 of FIG. 5.

(4-11) A case in which the row addresses and the column addresses overlap (i=0 to 8), write-in to the addresses ADZi (i=0 to 8) is carried out after a zero permanent fault occurs, and patrol check is carried out according to FIG. 3.

(a) Because write-in to the addresses ADZi is carried out after a zero permanent fault occurs, the data of the addresses ADZi and the error correcting codes of the addresses ADZi are stored in the address ADZ.

(b) If any one of address lines corresponding to the addresses ADi (i=0 to 8) has a zero permanent fault, the data reading unit 101 reads the address ADZ when it reads the addresses ADi, and therefore, the error detecting/correcting unit 102 detects that the bits corresponding to the address line have a single bit error, based on the addresses ADi and the error correcting codes of the addresses ADZi stored in the address ADZ, and then corrects the detected bit error from 1 to 0.

(c) If any one of the address lines corresponding to the addresses ADi has the zero permanent fault, the data reading unit 101 reads the data and the error correcting code of the address ADZ when it reads the address ADZ, and therefore, the error detecting/correcting unit 102 detects double bit-errors, based on the address ADZ and the error correcting codes of the addresses ADZi stored in the address ADZ.

(d) Accordingly, the permanent fault deciding unit 103 cannot decide whether the concerned address line has a zero permanent fault, based on the results of error detection/correction of (b) and (c).

(4-12) A case in which the row addresses and the column addresses overlap (i=0 to 8), write-in to the addresses ADi is carried out after a one permanent fault occurs, and patrol check is carried out according to FIG. 3.

(a) Because write-in to the addresses ADi (i=0 to 8) is carried out after a one permanent fault occurs, the data of the addresses ADi and the error correcting codes of the addresses ADi are stored in the addresses ADZi (i=0 to 8).

(b) If any one of address lines corresponding to the addresses ADi has a one permanent fault, the data reading unit 101 reads the data and the error correcting codes of the addresses ADZi when it reads the addresses ADi, and therefore, the error detecting/correcting unit 102 detects no bit error, based on the addresses ADi and the error correcting codes of the addresses ADi stored in the addresses ADZi.

(c) If any one of the address lines corresponding to the addresses ADi has the one permanent fault, the data reading unit 101 reads the data and the error correcting codes of the addresses ADZi when it reads the address ADZ, and therefore, the error detecting/correcting unit 102 detects that the bits corresponding to the address line have a single bit error, based on the address ADZ and the error correcting codes of the addresses ADi stored in the addresses ADZi, and then corrects the detected bit error from 0 to 1.

(d) Accordingly, the permanent fault deciding unit 103 decides that the concerned address line has a one permanent fault, based on the results of error detection/correction of (b) and (c) as shown in case C2 of FIG. 5.

(4-13) A case in which the row addresses and the column addresses overlap (i=0 to 8), write-in to the address ADZ is carried out after a one permanent fault occurs, and patrol check is carried out according to FIG. 3.

(a) Because write-in to the address ADZ is carried out after a one permanent fault occurs, the data of the address ADZ and the error correcting code of the address ADZ are stored in the addresses ADZi (i=0 to 8).

(b) If any one of address lines corresponding to the addresses ADi (i=0 to 8) has a one permanent fault, the data reading unit 101 reads the addresses ADZi when it reads the addresses ADi, and therefore, the error detecting/correcting unit 102 detects that the bits corresponding to the address line have a single bit error, based on the addresses ADi and the error correcting code of the address ADZ stored in the addresses ADZi, and then corrects the detected bit error from 0 to 1.

(c) If any one of the address lines corresponding to the addresses ADi has the one permanent fault, the data reading unit 101 reads the data and the error correcting codes of the addresses ADZi when it reads the address ADZ, and therefore, the error detecting/correcting unit 102 detects no bit error, based on the address ADZ and the error correcting code of the ADZ stored in the addresses ADZi.

(d) Accordingly, the permanent fault deciding unit 103 decides that the concerned address line has a one permanent fault, based on the results of error detection/correction of (b) and (c) as shown in case C4 of FIG. 5.

(4-14) A case in which the row addresses and the column addresses overlap (i=0 to 8), write-in to the addresses ADZi is carried out after a one permanent fault occurs, and patrol check is carried out according to FIG. 3. (

a) Because write-in to the addresses ADZi (i=0 to 8) is carried out after a one permanent fault occurs, the data of the addresses ADZi and the error correcting codes of the addresses ADZi are stored in the addresses ADZi.

(b) If any one of address lines corresponding to the addresses ADi (i=0 to 8) has a one permanent fault, the data reading unit 101 reads the addresses ADZi when it reads the addresses ADi, and therefore, the error detecting/correcting unit 102 detects that the bits corresponding to the address line have a single bit error, based on the addresses ADi and the error correcting codes of the addresses ADZi stored in the addresses ADZi, and then corrects the detected bit error from 0 to 1.

(c) If any one of the address lines corresponding to the addresses ADi has the one permanent fault, the data reading unit 101 reads the data and the error correcting codes of the addresses ADZi when it reads the address ADZ, and therefore, the error detecting/correcting unit 102 detects double bit errors, based on the address ADZ and the error correcting codes of the addresses ADZi stored in the addresses ADZi.

(d) Accordingly, the permanent fault deciding unit 103 cannot decide whether the concerned address line has a one permanent fault, based on the results of error detection/correction of (b) and (c).

(4-15) A case in which the row addresses and the column addresses overlap (i=0 to 8), write-in to the addresses adi (i=0 to 8) is carried out after a zero permanent fault occurs, and patrol check is carried out according to FIG. 4.

(a) Because write-in to the addresses adi is carried out after a zero permanent fault occurs, the data of the addresses adi and the error correcting codes of the addresses adi are stored in the addresses adci (i=0 to 8).

(b) If any one of address lines corresponding to the addresses adi has a zero permanent fault, the data reading unit 101 reads the data and the error correcting codes of the addresses adci when it reads the addresses adi, and therefore, the error detecting/correcting unit 102 detects no bit error, based on the addresses adi and the error correcting codes of the addresses adi stored in the addresses adci.

(c) If any one of the address lines corresponding to the addresses adi has the zero permanent fault, the data reading unit 101 reads the data and the error correcting codes of the addresses adci when it reads the address adc, and therefore, the error detecting/correcting unit 102 detects that the bits corresponding to the address line have a single bit error, based on the address adc and the error correcting codes of the addresses adi stored in the addresses adci, and then corrects the detected bit error from 1 to 0.

(d) Accordingly, the permanent fault deciding unit 103 decides that the concerned address line has a zero permanent fault, based on the results of error detection/correction of (b) and (c) as shown in case C5 of FIG. 5.

(4-16) A case in which the row addresses and the column addresses overlap (i=0 to 8), write-in to the address adc is carried out after a zero permanent fault occurs, and patrol check is carried out according to FIG. 4.

(a) Because write-in to the address adc is carried out after a zero permanent fault occurs, the data of the address adc and the error correcting code of the address adc are stored in the addresses adci (i=0 to 8).

(b) If any one of address lines corresponding to the addresses adi (i=0 to 8) has a zero permanent fault, the data reading unit 101 reads the addresses adci when it reads the addresses adi, and therefore, the error detecting/correcting unit 102 detects that the bits corresponding to the address line have a single bit error, based on the addresses adi and the error correcting code of the address adc stored in the addresses adci, and then corrects the detected bit error from 1 to 0.

(c) If any one of the address lines corresponding to the addresses adi has the zero permanent fault, the data reading unit 101 reads the data and the error correcting codes of the addresses adci when it reads the address adc, and therefore, the error detecting/correcting unit 102 detects no bit error, based on the address adc and the error correcting code of the adc stored in the addresses adci.

(d) Accordingly, the permanent fault deciding unit 103 decides that the concerned address line has a zero permanent fault, based on the results of error detection/correction of (b) and (c) as shown in case C7 of FIG. 5.

(4-17) A case in which the row addresses and the column addresses overlap (i=0 to 8), write-in to the addresses adci (i=0 to 8) is carried out after a zero permanent fault occurs, and patrol check is carried out according to FIG. 4

(a) Because write-in to the addresses adci is carried out after a zero permanent fault occurs, the data of the addresses adci and the error correcting codes of the addresses adci are stored in the addresses adci.

(b) If any one of address lines corresponding to the addresses adi (i=0 to 8) has a zero permanent fault, the data reading unit 101 reads the addresses adci when it reads the addresses adi, and therefore, the error detecting/correcting unit 102 detects that the bits corresponding to the address line have a single bit error, based on the addresses adi and the error correcting codes of the addresses adci stored in the addresses adci, and then corrects the detected bit error from 1 to 0.

(c) If any one of the address lines corresponding to the addresses adi has the zero permanent fault, the data reading unit 101 reads the data and the error correcting codes of the addresses adci when it reads the address adc, and therefore, the error detecting/correcting unit 102 detects double bit errors, based on the address adc and the error correcting codes of the addresses adci stored in the addresses adci.

(d) Accordingly, the permanent fault deciding unit 103 cannot decide whether the concerned address line has a zero permanent fault, based on the results of error detection/correction of (b) and (c).

(4-18) A case in which the row addresses and the column addresses overlap (i=0 to 8), write-in to the addresses adi (i=0 to 8) is carried out after a one permanent fault occurs, and patrol check is carried out according to FIG. 4.

(a) Because write-in to the addresses adi is carried out after a one permanent fault occurs, the data of the addresses adi and the error correcting codes of the addresses adi are stored in the address adc.

(b) If any one of address lines corresponding to the addresses adi has a one permanent fault, the data reading unit 101 reads the data and the error correction code of the address adc when it reads the addresses adi, and therefore, the error detecting/correcting unit 102 detects no bit error, based on the addresses adi and the error correcting codes of the addresses adi stored in the address adc.

(c) If any one of the address lines corresponding to the addresses adi has the one permanent fault, the data reading unit 101 reads the data and the error correcting code of the address adc when it reads the address adc, and therefore, the error detecting/correcting unit 102 detects that the bits corresponding to the address line have a single bit error, based on the address adc and the error correcting codes of the addresses adi stored in the address adc, and then corrects the detected bit error from 0 to 1.

(d) Accordingly, the permanent fault deciding unit 103 decides that the concerned address line has a one permanent fault, based on the results of error detection/correction of (b) and (c) as shown in case C6 of FIG. 5.

(4-19) A case in which the row addresses and the column addresses overlap (i=0 to 8), write-in to the address adc is carried out after a one permanent fault occurs, and patrol check is carried out according to FIG. 4.

(a) Because write-in to the address adc is carried out after a one permanent fault occurs, the data of the address adc and the error correcting code of the address adc are stored in the address adc.

(b) If any one of address lines corresponding to the addresses adi (i=0 to 8) has a one permanent fault, the data reading unit 101 reads the address adc when it reads the addresses adi, and therefore, the error detecting/correcting unit 102 detects that the bits corresponding to the address line have a single bit error, based on the addresses adi and the error correcting code of the address adc stored in the address adc, and then corrects the detected bit error from 0 to 1.

(c) If any one of the address lines corresponding to the addresses adi has the one permanent fault, the data reading unit 101 reads the data and the error correcting code of the address adc when it reads the address adc, and therefore, the error detecting/correcting unit 102 detects no bit error, based on the address adc and the error correcting code of the address adc stored in the address adc.

(d) Accordingly, the permanent fault deciding unit 103 decides that the concerned address line has a one permanent fault, based on the results of error detection/correction of (b) and (c) as shown in case C8 of FIG. 5.

(4-20) A case in which the row addresses and the column addresses overlap (i=0 to 8), write-in to the addresses adci (i=0 to 8) is carried out after a one permanent fault occurs, and patrol check is carried out according to FIG. 4.

(a) Because write-in to the addresses adci is carried out after a one permanent fault occurs, the data of the addresses adci and the error correcting codes of the addresses adci are stored in the address adc.

(b) If any one of address lines corresponding to the addresses adi (i=0 to 8) has a one permanent fault, the data reading unit 101 reads the address adc when it reads the addresses adi, and therefore, the error detecting/correcting unit 102 detects that the bits corresponding to the address line have a single bit error, based on the addresses adi and the error correcting codes of the addresses adci stored in the address adc, and then corrects the detected bit error from 0 to 1.

(c) If any one of the address lines corresponding to the addresses adi has the one permanent fault, the data reading unit 101 reads the data and the error correcting code of the address adc when it reads the address adc, and therefore, the error detecting/correcting unit 102 detects double bit errors, based on the address adc and the error correcting codes of the addresses adci stored in the address adc.

(d) Accordingly, the permanent fault deciding unit 103 cannot decide whether the concerned address line has a one permanent fault, based on the results of error detection/correction of (b) and (c).

(4-21) A case in which the row addresses and the column addresses do not overlap (i=9 to 14), write-in to the addresses ADi (i=9 to 14) is carried out after a zero permanent fault occurs, and patrol check is carried out according to FIG. 3.

(a) Because write-in to the addresses ADi is carried out after a zero permanent fault occurs, the data of the addresses ADi and the error correcting codes of the addresses ADi are stored in the address ADZ.

(b) If any one of address lines corresponding to the addresses ADi has a zero permanent fault, the data reading unit 101 reads the data and the error correcting code of the address ADZ when it reads the addresses ADi, and therefore, the error detecting/correcting unit 102 detects no bit error, based on the addresses ADi and the error correcting codes of the addresses ADi stored in the address ADZ.

(c) If any one of the address lines corresponding to the addresses ADi has the zero permanent fault, the data reading unit 101 reads the data and the error correcting code of the address ADZ when it reads the address ADZ, and therefore, the error detecting/correcting unit 102 detects that the bits corresponding to the address line have a single bit error, based on the address ADZ and the error correcting codes of the addresses ADi stored in the address ADZ, and then corrects the detected bit error from 0 to 1.

(d) Accordingly, the permanent fault deciding unit 103 decides that the concerned address line has a zero permanent fault, based on the results of error detection/correction of (b) and (c) as shown in case C1 of FIG. 5.

(4-22) A case in which the row addresses and the column addresses do not overlap (i=9 to 14), write-in to the address ADZ is carried out after a zero permanent fault occurs, and patrol check is carried out according to FIG. 3.

(a) Because write-in to the address ADZ is carried out after a zero permanent fault occurs, the data of the address ADZ and the error correcting code of the address ADZ are stored in the address ADZ.

(b) If any one of address lines corresponding to the addresses ADi (i=9 to 14) has a zero permanent fault, the data reading unit 101 reads the address ADZ when it reads the addresses ADi, and therefore, the error detecting/correcting unit 102 detects that the bits corresponding to the address line have a single bit error, based on the addresses ADi and the error correcting code of the address ADZ stored in the address ADZ, and then corrects the detected bit error from 1 to 0.

(c) If any one of the address lines corresponding to the addresses ADi has the zero permanent fault, the data reading unit 101 reads the data and the error correcting code of the address ADZ when it reads the address ADZ, and therefore, the error detecting/correcting unit 102 detects no bit error, based on the address ADZ and the error correcting code of the ADZ stored in the address ADZ.

(d) Accordingly, the permanent fault deciding unit 103 decides that the concerned address line has a zero permanent fault, based on the results of error detection/correction of (b) and (c) as shown in case C3 of FIG. 5.

(4-23) A case in which the row addresses and the column addresses do not overlap (i=9 to 14), write-in to the addresses ADi (i=9 to 14) is carried out after a one permanent fault occurs, and patrol check is carried out according to FIG. 3.

(a) Because write-in to the addresses ADi is carried out after a one permanent fault occurs, the data of the addresses ADi and the error correcting codes of the addresses ADi are stored in the addresses ADZi (i=9 to 14).

(b) If any one of address lines corresponding to the addresses ADi has a one permanent fault, the data reading unit 101 reads the data and the error correcting codes of the addresses ADZi when it reads the addresses ADi, and therefore, the error detecting/correcting unit 102 detects no bit error, based on the addresses ADi and the error correcting codes of the addresses ADi stored in the addresses ADZi.

(c) If any one of the address lines corresponding to the addresses ADi has the one permanent fault, the data reading unit 101 reads the data and the error correcting codes of the addresses ADZi when it reads the address ADZ, and therefore, the error detecting/correcting unit 102 detects that the bits corresponding to the address line have a single bit error, based on the address ADZ and the error correcting codes of the addresses ADi stored in the addresses ADZi, and then corrects the detected bit error from 0 to 1.

(d) Accordingly, the permanent fault deciding unit 103 decides that the concerned address line has a one permanent fault, based on the results of error detection/correction of (b) and (c) as shown in case C2 of FIG. 5.

(4-24) A case in which the row addresses and the column addresses do not overlap (i=9 to 14), write-in to the address ADZ is carried out after a one permanent fault occurs, and patrol check is carried out according to FIG. 4.

(a) Because write-in to the address ADZ is carried out after a one permanent fault occurs, the data of the address ADZ and the error correcting code of the address ADZ are stored in the addresses ADZi (i=9 to 14).

(b) If any one of address lines corresponding to the addresses ADi (i=9 to 14) has a one permanent fault, the data reading unit 101 reads the addresses ADZi when it reads the addresses ADi, and therefore, the error detecting/correcting unit 102 detects that the bits corresponding to the address line have a single bit error, based on the addresses ADi and the error correcting code of the address ADZ stored in the addresses ADZi, and then corrects the detected bit error from 0 to 1.

(c) If any one of the address lines corresponding to the addresses ADi has the one permanent fault, the data reading unit 101 reads the data and the error correcting codes of the addresses ADZi when it reads the address ADZ, and therefore, the error detecting/correcting unit 102 detects no bit error, based on the address ADZ and the error correcting code of the ADZ stored in the addresses ADZi.

(d) Accordingly, the permanent fault deciding unit 103 decides that the concerned address line has a one permanent fault, based on the results of error detection/correction of (b) and (c) as shown in case C4 of FIG. 5.

(4-25) A case in which the row addresses and the column addresses do not overlap (i=9 to 14), write-in to the addresses adi (i=9 to 14) is carried out after a zero permanent fault occurs, and patrol check is carried out according to FIG. 4.

(a) Because write-in to the addresses adi is carried out after a zero permanent fault occurs, the data of the address adi and the error correcting codes of the addresses adi are stored in the addresses adi.

(b) If any one of address lines corresponding to the addresses adi has a zero permanent fault, the data reading unit 101 reads the data and the error correcting codes of the addresses adi when it reads the addresses adi, and therefore, the error detecting/correcting unit 102 detects no bit error, based on the addresses adi and the error correcting codes of the addresses adi stored in the addresses adi.

(c) If any one of the address lines corresponding to the addresses adi has the zero permanent fault, the data reading unit 101 reads the data and the error correcting codes of the addresses adi when it reads the address adc, and therefore, the error detecting/correcting unit 102 detects that the bits corresponding to the address line have a single bit error, based on the address adc and the error correcting codes of the addresses adi stored in the addresses adi, and then corrects the detected bit error from 1 to 0.

(d) Accordingly, the permanent fault deciding unit 103 decides that the concerned address line has a zero permanent fault, based on the results of error detection/correction of (b) and (c) as shown in case C5 of FIG. 5.

(4-26) A case in which the row addresses and the column addresses do not overlap (i=9 to 14), write-in to the address adc is carried out after a zero permanent fault occurs, and patrol check is carried out according to FIG. 4.

(a) Because write-in to the address adc is carried out after a zero permanent fault occurs, the data of the address adc and the error correcting code of the address adc are stored in the addresses adi (i=9 to 14).

(b) If any one of address lines corresponding to the addresses adi has a zero permanent fault, the data reading unit 101 reads the addresses adi when it reads the addresses adi, and therefore, the error detecting/correcting unit 102 detects that the bits corresponding to the address line have a single bit error, based on the addresses adi and the error correcting code of the address adc stored in the addresses adi, and then corrects the detected bit error from 1 to 0.

(c) If any one of the address lines corresponding to the addresses adi has the zero permanent fault, the data reading unit 101 reads the data and the error correcting codes of the addresses adi when it reads the address adc, and therefore, the error detecting/correcting unit 102 detects no bit error, based on the address adc and the error correcting code of the address adc stored in the addresses adi.

(d) Accordingly, the permanent fault deciding unit 103 decides that the concerned address line has a zero permanent fault, based on the results of error detection/correction of (b) and (c) as shown in case C7 of FIG. 5.

(4-27) A case in which the row addresses and the column addresses do not overlap (i=9 to 14), write-in to the addresses adi (i=9 to 14) is carried out after a one permanent fault occurs, and patrol check is carried out according to FIG. 4.

(a) Because write-in to the addresses adi is carried out after a one permanent fault occurs, the data of the addresses adi and the error correcting codes of the addresses adi are stored in the address adc.

(b) If any one of address lines corresponding to the addresses adi has a one permanent fault, the data reading unit 101 reads the data and the error correcting code of the address adc when it reads the addresses adi, and therefore, the error detecting/correcting unit 102 detects no bit error, based on the addresses adi and the error correcting codes of the addresses adi stored in the address adc.

(c) If any one of the address lines corresponding to the addresses adi has the one permanent fault, the data reading unit 101 reads the data and the error correcting code of the address adc when it reads the address adc, and therefore, the error detecting/correcting unit 102 detects that the bits corresponding to the address line have a single bit error, based on the address adc and the error correcting codes of the addresses adi stored in the address adc, and then corrects the detected bit error from 0 to 1.

(d) Accordingly, the permanent fault deciding unit 103 decides that the concerned address line has a one permanent fault, based on the results of error detection/correction of (b) and (c) as shown in case C6 of FIG. 5.

(4-28) A case in which the row addresses and the column addresses do not overlap (i=9 to 14), write-in to the address adc is carried out after a one permanent fault occurs, and patrol check is carried out according to FIG. 4.

(a) Because write-in to the address adc is carried out after a one permanent fault occurs, the data of the address adc and the error correcting code of the address adc are stored in the address adc.

(b) If any one of address lines corresponding to the addresses adi (i=9 to 14) has a one permanent fault, the data reading unit 101 reads the address adc when it reads the addresses adi, and therefore, the error detecting/correcting unit 102 detects that the bits corresponding to the address line have a single bit error from the addresses adi and the error correcting code of the address adc stored in the address adc, followed by correcting the detected bit error from 0 to 1.

(c) If any one of the address lines corresponding to the addresses adi has the one permanent fault, the data reading unit 101 reads the data and the error correcting code of the address adc when it reads the address adc, and therefore, the error detecting/correcting unit 102 detects no bit error, based on the address adc and the error correcting code of the address adc stored in the address adc.

(d) Accordingly, the permanent fault deciding unit 103 decides that the concerned address line has a one permanent fault, based on the results of error detection/correction of (b) and (c) as shown in case C8 of FIG. 5.

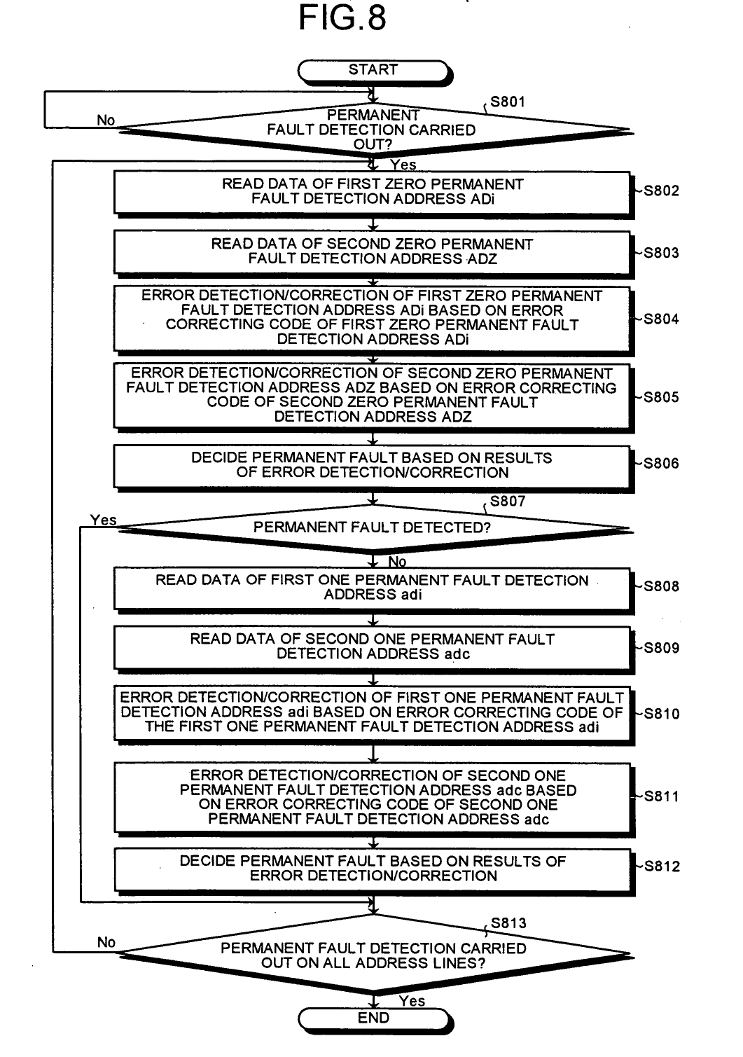

Next, process procedures of permanent fault detection on the address lines, performed by the control device 10 are explained with reference to a flowchart shown in FIG. 8. The control device 10 confirms whether permanent fault detection on the address lines is executed (step S801). For example, the control device 10 carries out permanent fault detection on the address lines, when a request of permanent fault detection on the address lines is sent by a user, or periodically after a predetermined time set by a timer or the like.

First, the data reading unit 101 reads the data of the first zero permanent fault detection address ADi (step S802), and consecutively reads the data of the second zero permanent fault detection address ADZ (step S803). Then, the error detecting/correcting unit 102 carries out error detection/correction of the first zero permanent fault detection address ADi, based on the error correcting code of the first zero permanent fault detection address ADi (step S804). Further, the error detecting/correcting unit 102 carries out error detection/correction of the second zero permanent fault detection address ADZ based on the error correcting code of the second zero permanent fault detection address ADZ (step S805). Then, the permanent fault deciding unit 103 decides a zero permanent fault or a one permanent fault on the address line as shown in FIG. 5, based on the results of error detection/correction (step S806).

Next, the control device 10 confirms whether a permanent fault is detected on an address line (step S807). If a permanent fault is detected on the address line (Yes at step S807), the control device 10 proceeds to step S813, and carries out the permanent fault detection procedures for the next address line.

On the other hand, if a permanent fault on the address line cannot be detected (No at step S807), the data reading unit 101 reads the data of the first one permanent fault detection address adi (step S808), and reads consecutively, the data of the second one permanent fault detection address adc (step S809). Then, the error detecting/correcting unit 102 carries out error detection/correction for the first one permanent fault detection address adi, based on the error correcting code of the first one permanent fault detection address adi (step S810). Further, the error detecting/correcting unit 102 carries out error detection/correction for the error correcting code of the second one permanent detection address adc, based on the error correcting code of the second one permanent fault detection address adc (step S811). Then, the permanent fault deciding unit 103 decides a zero permanent fault or a one permanent fault on the address line as shown in FIG. 5, based on the results of error detection/correction (step S812).

Finally, the control device 10 confirms whether permanent fault detection is carried out on all address lines (step S813). If permanent fault detection is not carried out for all address lines (No at step S813), the control device 10 returns to the step S802, and repeats the procedures of the steps S802 to S812. On the other hand, if permanent fault detection is carried out for all address lines (Yes at step S813), the control device 10 terminates the procedures.

As described in the foregoing, in the first embodiment, arbitrary data includes error correcting codes of addresses. The data reading unit 101 reads out arbitrary data from a memory, based on one or both of the zero permanent fault detection addresses that are addresses to detect a zero permanent fault on address lines, and the one permanent fault detection addresses that are addresses to detect a one permanent fault on a plurality of the address lines. The error detecting/correcting unit 102 detects/corrects a bit error on one or both of the zero permanent fault detection addresses and the one permanent fault detection addresses, based on the error correcting codes included in the arbitrary data read. Then, the permanent fault deciding unit 103 decides a zero permanent fault or a one permanent fault on the address lines, based on the results of error detection/correction provided by the error detecting/correcting unit 102. Therefore, the control device 10 can specify a zero permanent fault or a one permanent fault on address lines efficiently, without writing permanent fault detection data to the main storage device during the system operation.

Further, the address bus specifies an address with a row address and a column address via the same address line by time sharing. The zero permanent fault detection address includes a first zero permanent fault detection address having any one arbitrary bit of one or both of the row address and the column address corresponding to an address line set to 1, and all the other bits to 0, and a second zero permanent fault detection address having all bits set to 0. The one permanent fault detection address includes a first one permanent fault detection address having any one arbitrary bit of one or both of the row address and the column address corresponding to an address line set to 0, and all the other bits to 1, and a second one permanent fault detection address having all bits set to 1. Therefore, the control device 10 can generate a zero permanent fault detection address or a one permanent fault detection address easily.

Furthermore, a single bit error can be corrected and double bit errors can be detected, using the error correcting codes. Therefore, the control device 10 can detect a zero permanent fault or a one permanent fault on address lines only by reading out arbitrary data from the zero permanent fault detection address or the one permanent fault detection address.

Further, the data reading unit 101 reads out arbitrary data from the first zero permanent fault detection address and the second zero permanent fault detection address, the error detecting/correcting unit 102 detects/corrects the bit errors on the first zero permanent fault detection address and the second zero permanent fault detection address, based on the error correcting codes included in the respective arbitrary data read out. The permanent fault deciding unit 103 decides that a one permanent fault occurs on the address line if a single bit error is corrected from 0 to 1, and that a zero permanent fault occurs on the address line if a single bit error is corrected from 1 to 0, in a case where either of the first zero permanent fault detection address or the second zero permanent fault detection address has the single bit error and the other has no bit error with respect to the bits corresponding to the address line. Therefore, the control device 10 can specify a zero permanent fault or a one permanent fault on address lines easily and efficiently, based on the results of error detection/correction.

Furthermore, the data reading unit 101 reads out arbitrary data from the first one permanent fault detection address and the second one permanent fault detection address, the error detecting/correcting unit 102 detects/corrects the bit errors on the first one permanent fault detection address and the second one permanent fault detection address, based on the error correcting codes included in the respective arbitrary data read out. The permanent fault deciding unit 103 decides that a one permanent fault occurs on the address line if a single bit error is corrected from 0 to 1, and that a zero permanent fault occurs on the address line when a single bit error is corrected from 1 to 0, in a case where either of the first one permanent fault detection address or the second one permanent fault detection address has the single bit error and the other has no bit error with respect to the bits corresponding to the address line. Therefore, the control device 10 can specify a zero permanent fault or a one permanent fault on address lines easily and efficiently, based on the results of error detection/correction.

The control device and the method of permanent fault detection on address lines explained in the above first embodiment can be realized by executing a program prepared in advance, on a computer system such as personal computer and workstation. A computer system that executes a program of permanent fault detection on address lines, having a function similar to that of the control device explained in the above first embodiment, is explained as a second embodiment.

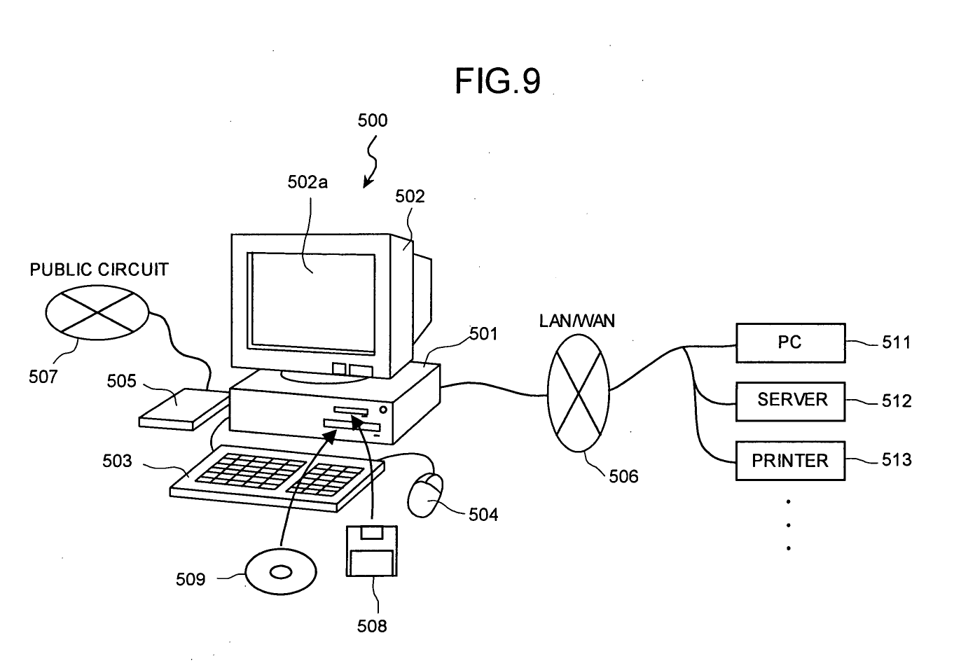

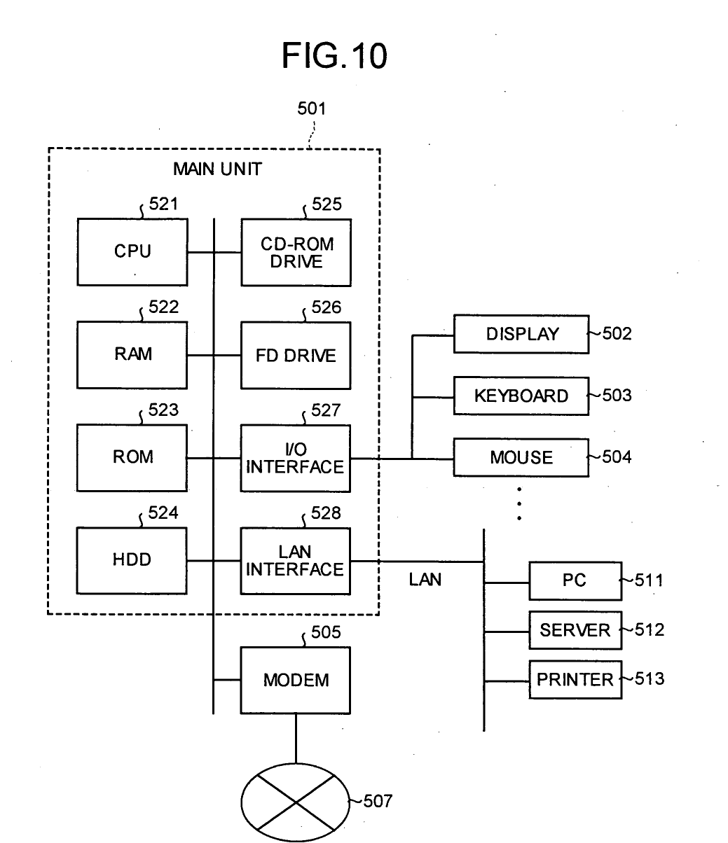

FIG. 9 illustrates a system configuration of a computer system according to the second embodiment. FIG. 10 is a block diagram of a configuration of a main unit in the computer system shown in FIG. 9. As shown in FIG. 9, a computer system 500 according to the present embodiment includes a main unit 501, a display 502 that displays information such as image on a display screen 502a upon an instruction from the main unit 501, a keyboard 503 that inputs various information to the computer system 500, and a mouse 504 that is used to designate an arbitrary position on the display screen 502a of the display 502.

Further, as shown in FIG. 10, the main unit 501 in the computer system 500 includes a central processing unit (CPU) 521, a random access memory (RAM) 522, a read only memory (ROM) 523, a hard disk drive (HDD) 524, a compact disc (CD)-ROM drive 525 that accesses a CD-ROM 509 (see FIG. 9), a flexible disk (FD) drive 526 that accesses an FD 508 (see FIG. 9), an I/O interface 527 that connects the display 502, the keyboard 503, and the mouse 504, and a local area network (LAN) interface 528 that connects to a local area network or wide area network (LAN/WAN) 506 (see FIG. 9).

Furthermore, the computer system 500 is connected to a modem 505 to connect a public circuit 507 such as the Internet, and also to another computer system 511, a server 512, a printer 513, and the like via the LAN interface 528 and the LAN/WAN 506.

In the computer system 500, the functions of the control device are realized by reading out and executing the program of permanent fault detection on address lines, recorded in a predetermined recording medium. Here, the predetermined recording medium includes all computer-readable recording media that can record the program of permanent fault detection on address lines, such as “portable physical media” like the FD 508, the CD-ROM 509, magnetic optical (MO) disk, digital video disc (DVD), optical magnetic disc, and integrated circuit (IC) card, as well as “fixed physical media” such as the HDD 524, the RAM 522, and the ROM 523 that are provided internally or externally to the computer system 500, “communication media” that store programs temporarily on transmitting the programs, such as the public circuit 507 connected via the modem 505 and the LAN/WAN 506, to which the computer system 511 and the server 512 are connected.

In other words, the program of permanent fault detection on address lines is recorded in recording media such as the portable physical media, fixed physical media, and communication media described above, in a way that a computer can read the program. The computer system 500 realizes the control device and the method of permanent fault detection on address lines by reading and then executing the program of permanent fault detection on address lines from such a recording medium. The program of permanent fault detection on address lines is not limited to be executed by the computer system 500, but the present invention can be applied in a similar manner to cases in which another computer system 511 or the server 512 executes the program of permanent fault detection on address lines, and in which the computer system and the server coordinate with each other to execute the program of permanent fault detection on address lines.

In the foregoing, the embodiments of the present invention have been explained. However, the present invention can be implemented in various modes within the scope of the technical idea described above in the scope of the claim for patent besides the above embodiments.

For example, in the first embodiment, a permanent fault on an address line is decided based on the results of error detection/correction of bits corresponding to the respective 15 address lines on which bit error detection/correction is carried out. However, the present invention is not limited to the above. Moreover, the present invention can be applied to a case of specifying bits having a single bit error based on a result of error detection/correction of bits corresponding to the address line, and deciding a permanent fault on an address line with respect to the specified bits. In this manner, decision can be made more efficiently than deciding a permanent fault on all of the 15 address lines sequentially.

According to the present invention, the control device can specify a permanent fault on address lines efficiently, without writing a permanent fault detection data to the main storage device during the system operation.

Moreover, the control device can generate a zero permanent fault detection address or a one permanent fault detection address easily.

Furthermore, the control device can detect a zero permanent fault or a one permanent fault on address lines only by reading out arbitrary data from the zero permanent fault detection address or the one permanent fault detection address.

Moreover, the control device can specify a permanent fault on an address line easily and efficiently, based on the results of error detection/correction.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A control device comprising:
a memory that stores arbitrary data, wherein the arbitrary data is read/written based on an address specified via an address bus that includes a plurality of address lines, and the arbitrary data includes an error correcting code of the address;
a data reading unit that reads out the arbitrary data from the memory, based on a permanent fault detection address that is used to detect a permanent fault on the address line;
an error detecting/correcting unit that detects/corrects a bit error in the permanent fault detection address, based on the error correcting code; and
a permanent fault deciding unit that decides any one of a zero-permanent-fault and a one-permanent-fault on the address line, based on results of the error detection/correction performed.

2. The control device according to claim 1, wherein
the address bus specifies the address by specifying a row address and a column address, by time sharing the address line;
the permanent fault detection address includes a first zero-permanent-fault detection address, a second zero-permanent-fault detection address, a first one-permanent-fault detection address, and a second one-permanent-fault detection address, corresponding to the address line, wherein
in the first zero-permanent-fault detection address, an arbitrary bit of at least one of the row address and the column address is set to 1, and all other bits are set to 0,
in the second zero-permanent-fault detection address, all bits are set to 0,
in the first one-permanent-fault detection address, an arbitrary bit of at least one of the row address and the column address is set to 0, and all other bits are set to 1, and
in the second one-permanent-fault detection address, all bits are set to 1.

3. The control device according to claim 1, wherein the error correcting code is used to correct a single bit error, and to detect a double bit error.

4. The control device according to claim 2, wherein
the data reading unit reads out the arbitrary data from the first zero-permanent-fault detection address and the second zero-permanent-fault detection address;
the error detecting/correcting unit detects/corrects the bit error on the first zero-permanent-fault detection address and the second zero-permanent-fault detection address, based on the error detecting code; and
if any one of the first zero-permanent-fault detection address and the second zero-permanent-fault detection address has a single bit error, and the other has no bit error with respect to the bits corresponding to the address line, then the permanent fault deciding unit decides that a one-permanent-fault occurs on the address line when the single bit error is corrected from 0 to 1, and that a zero-permanent-fault occurs on the address line when the single bit error is corrected from 1 to 0.

5. The control device according to claim 2, wherein
the data reading unit reads out the arbitrary data from the first one-permanent-fault detection address and the second one-permanent-fault detection address;
the error detecting/correcting unit detects/corrects the bit error on the first one-permanent-fault address and the second one-permanent-fault address, based on the error correcting code; and
if any one of the first one-permanent-fault detection address and the second one-permanent-fault detection address has a single bit error, and the other has no bit error with respect to the bits corresponding to the address line, then the permanent fault deciding unit decides that a one-permanent-fault occurs on the address line when the single bit error is corrected from 0 to 1, and that a zero-permanent-fault occurs on the address line when the single bit error is corrected from 1 to 0.

6. A method of detecting a permanent fault on an address line, the address line specifying an address of arbitrary data that includes an error correcting code of the address, the method comprising:
reading out the arbitrary data from a memory, based on a permanent fault detection address that is used to detect a permanent fault on the address line;
detecting a bit error in the permanent fault detection address, based on the error correcting code;
correcting the bit error in the permanent fault detection address, based on the error correcting code; and
deciding any one of a zero-permanent-fault and a one-permanent-fault on the address line, based on results obtained at the detecting and at the correcting.

7. A recording medium that stores therein, a computer program for detecting a permanent fault on an address line, the address line specifying an address of arbitrary data that includes an error correcting code of the address, the computer program including instructions, which when executed, cause a computer to execute:
reading out the arbitrary data from a memory, based on a permanent fault detection address that is used to detect a permanent fault on the address line;
detecting a bit error in the permanent fault detection address, based on the error correcting code;
correcting the bit error in the permanent fault detection address, based on the error correcting code; and
deciding any one of a zero-permanent-fault and a one-permanent-fault on the address line, based on results obtained at the detecting and at the correcting.
